(19) United States
(12) Patent Application Publication
(10) Pub. No.: US 2012/0144954 A1
(43) Pub. Date: Jun. 14, 2012

(54) ADVANCED STEERING WHEEL

(76) Inventor: Makoto Takayasu, Lexington, MA (US)

(21) Appl. No.: 13/213,476

(22) Filed: Aug. 19, 2011

Related U.S. Application Data
(60) Provisional application No. 61/459,177, filed on Dec. 9, 2010.

(51) Int. Cl. B62D 1/04

(52) U.S. Cl. 74/552

(57) ABSTRACT

An advanced steering wheel is disclosed, where most of the surface area of the invented steering wheel, with the exception of the outer wheel ring, does not need to rotate. In this way, the central part of the steering wheel can be used for various purposes, such as information displays, various devices (such as cell phones, GPS receiver), etc. as well as the air bag and horn pad. Unlike rotational spokes and the hub of a conventional steering wheel, the inventive steeling wheel uses a mechanical coupling device such as a gear system or a belt and pulley system. When a vehicle driver rotates the steering wheel ring, the rotational driving motion is transferred to the steering shaft spindle by the mechanical coupling devices, which are mounted under the steering wheel surface. The surface area of the steering wheel can be used for various utility consoles and accessories.

This application claims priority to U.S. Provisional Patent Application Ser. No. 61/459,177 filed Dec. 9, 2010, the disclosure of which is incorporated by reference herein.

### TECHNICAL FIELD

The invention relates to a steering wheel.

### BACKGROUND OF THE INVENTION

In conventional steering wheels, a steering wheel is made up of a steering wheel ring, a hub and one or more radial spokes. The steering wheel ring is connected to the hub of a steering wheel with one or more radial steering wheel spokes. The steering wheel hub causes the steering shaft spindle to rotate. Other modules, such as an air bag and a horn pad, may also be contained in, or disposed on, the steering wheel hub.

When the driver rotates the steering wheel of a vehicle, the steering wheel ring and the spokes are all rotated together with the hub of the spindle. Because the entire assembly rotates, there are limitations with this configuration. For example, the wheel is necessarily round. A different shape may be far from the drive's legs in one position, but too close to the driver's legs while being rotated.

Furthermore, the utilization of the steering wheel central area of about 15″ diameter has very limited uses, such as a horn pad and an air bag. Other functions are not included on the hub, since there are times when these functions will be inverted or sideways, such as while turning. For example, adding gauges or meters, such as fuel gauges, speedometers or tachometers is not practical because of this rotation.

In addition, the rotation of the steering wheel also impedes the driver's ability to read the gauges on the dashboard, such as during a turn or curve, because the radial stoke may be in the line of view.

Therefore, there are numerous shortcomings that are the result of having the entire steering wheel assembly rotate.

### SUMMARY OF THE INVENTION

An advanced steering wheel is disclosed, where the central area within the outer wheel ring does not need to rotate. Unlike rotational spokes and the hub of a conventional steering wheel, the inventive steeling wheel uses a mechanical device, such as a gear system or a belt and pulley system. When a vehicle driver rotates the steering wheel ring, the rotational driving motion is transferred to the steering shaft spindle by the mechanical devices, which are mounted under the steering wheel surface.

In this way, the invention makes it possible to utilize modules in the central area of a steering wheel, which preferably is stationary and should not rotate. This central part of the steering wheel can then be used for various purposes, such as information displays, various devices (such as cell phones, GPS receiver), as well as the air bag and horn pad.

### BRIEF DESCRIPTION OF THE DRAWINGS

FIG. 1(a) is a top view of a steering wheel illustrating mechanical coupling arrangements according to one embodiment according to this invention.

FIG. 1(b) is a perspective view of the steering wheel of FIG. 1(a) with a vehicle steering column of the steering spindle.

FIG. 2 is a cross-section of a part of the steering wheel outer ring, the gear system, the wheel shaft spindle and the structure frame, according to one embodiment.

FIGS. 3(a) and (b) illustrate other embodiments utilizing alternative gear arrangements.

FIG. 4(a) and (b) illustrate other embodiments, which utilizes a gear system having two supporting gears.

FIG. 5 illustrates another embodiment illustrating a mechanical coupling mechanism, which utilizes a system having a belt.

FIGS. 6(a) and (b) illustrate examples of triangular and rectangular steering wheels, respectively.

FIG. 7 illustrates an example of an elliptical shaped steering wheel.

FIG. 8 illustrates an embodiment of the central surface of a steering wheel providing an open area at the top half sector.

FIG. 9 illustrates another embodiment of the entire surface area of a steering wheel providing for gauge meters, other utilities and accessories.

FIG. 10(a) and (b) illustrate the entire surface area of a triangular and rectangular steering wheel, respectively, providing for gauge meters, other utilities and accessories.

FIG. 11 illustrates the entire surface area of an elliptical steering wheel providing for gauge meters, other utilities and accessories.

### DETAILED DESCRIPTION OF THE INVENTION

The present invention allows the region inside the steering wheel ring, which is typically a circular area used for the spokes and the hub in a conventional steering wheel, to remain stationary during turning operations. This circular central area has a diameter of about 15″. Because it remains stationary, the central area of the steering wheel can be used for various purposes. For example, utility consoles and accessories for safe driving, including multi-information displays for vehicle control system monitors, such as speedometer, tachometer, temperature fuel gauge, clock, radio, and other digital equipment, may be added. The central area can also be used for compartments to mount various devices such as a cell phone, a GPS receiver, or other devices. An air bag and a horn pad can be mounted at the central area in a similar way as a conventional vehicle steering wheel. Furthermore, the invention also allows improvements and flexibilities of a vehicle dashboard design and usage.

In the present invention, when a driver rotates the steering wheel ring while driving a vehicle, the rotational force is transferred to the steering shaft spindle by a mechanical coupling device, such as gear and belt/pulley mechanical systems. The mechanical coupling device may be located under the central area of the steering wheel. In this way, the central area of the steering wheel remains stationary and does not rotate.

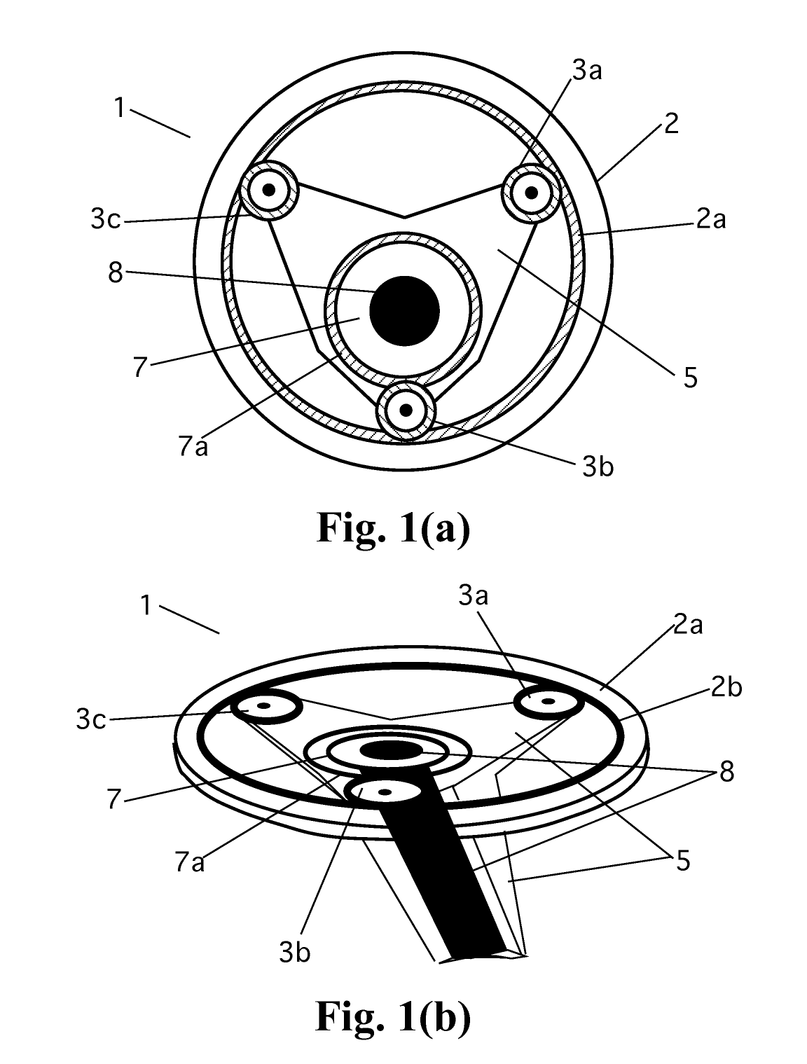

FIGS. 1(a) and 1(b) illustrate a first embodiment, where the mechanical coupling device is a mechanical gear system used to rotate the steering spindle 8 by rotating the steering wheel ring 2. FIG. 1(a) shows a view of the steering wheel 1 constructed without the central area cover, in order to show the operating mechanism of the steering wheel 1. FIG. 1(b) is a perspective view showing the steering wheel 1 attached to a steering wheel shaft spindle 8.

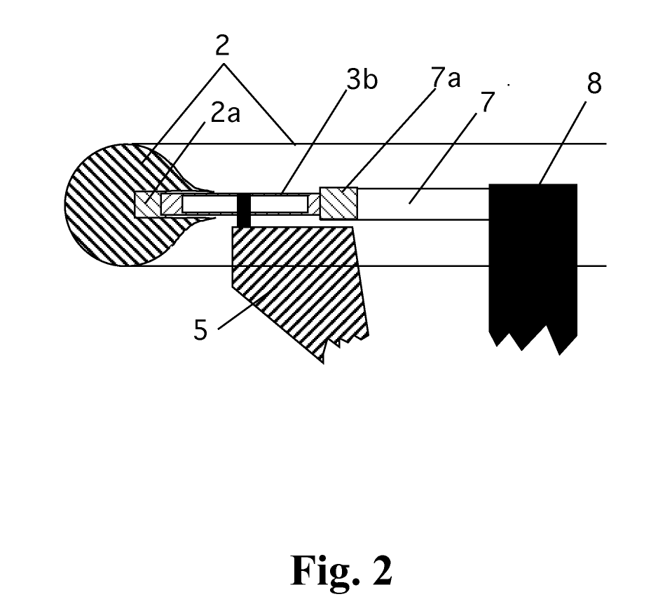

FIG. 2 shows one embodiment of a cross-section of a part of the steering wheel outer ring 2, including the gear system, which comprises gears 3b and 7, the wheel shaft spindle 8 and the structure frame 5. The inner surface wall of the outer ring 2 of the steering wheel 1 preferably is formed to contain gear teeth 2a. The inner surface wall is a wall on the inner perimeter of the outer ring, facing toward the central area. The gear teeth 2a may be molded into the outer ring 2, or may be affixed to the inner surface wall of the outer ring 2. Thus, gear teeth 2a is an internal gear, which is formed or affixed to the inner surface of the ring 2.

Returning to FIG. 1(a), the supporting gears 3a, 3b and 3c are mounted on a structure frame 5 of a steering wheel housing of a vehicle. The gears 3a, 3b and 3c support the steering wheel ring 2 in place, as shown in FIG. 1(a). One of the gears, for example, 3b in FIG. 1(a), is in contact with the gear teeth 7a of the gear 7, which may be rigidly mounted on the spindle shaft 8. The steering shaft spindle 8 can be rotated through the gear system comprising gears 2a, 3b and 7a by a rotation of the steering wheel ring 2. In this way, the steering spindle 8 is rotated when the steering wheel ring 2 is rotated. Note that the gear arrangement in FIG. 1(a) causes the steering wheel 2 to rotate the steering spindle 8 in a direction opposite the rotation of the steering wheel 2. In this embodiment, the spindle shaft system on a vehicle is mechanically configured to turn the car in the conventional manner based on the rotation of the steering wheel 2. Additional gear arrangements that allow the steering wheel 2 and the spindle shaft 8 to rotate in the same direction will be discussed later.

As seen in FIG. 1(a), the invention does not require that the steering shaft spindle 8 to be the center of the steering wheel ring 2.

Gear arrangements are not limited to the above examples. Various alternate gear arrangements may be designed and optimized, according to mechanical needs and steering wheel size, space and operation conveniences of rotation torque force and rotational turns, for driving a vehicle. The gear system may be designed taking into account a gear ratio to optimize the rotation angles and the rotation torque. In addition the gear types, such as spur gears of straight-cut gears and helical gears, may be selected based on known gear technology practices. Furthermore, additional gears, which are used to change the direction of rotation or change the mechanical advantage, may be added as necessary.

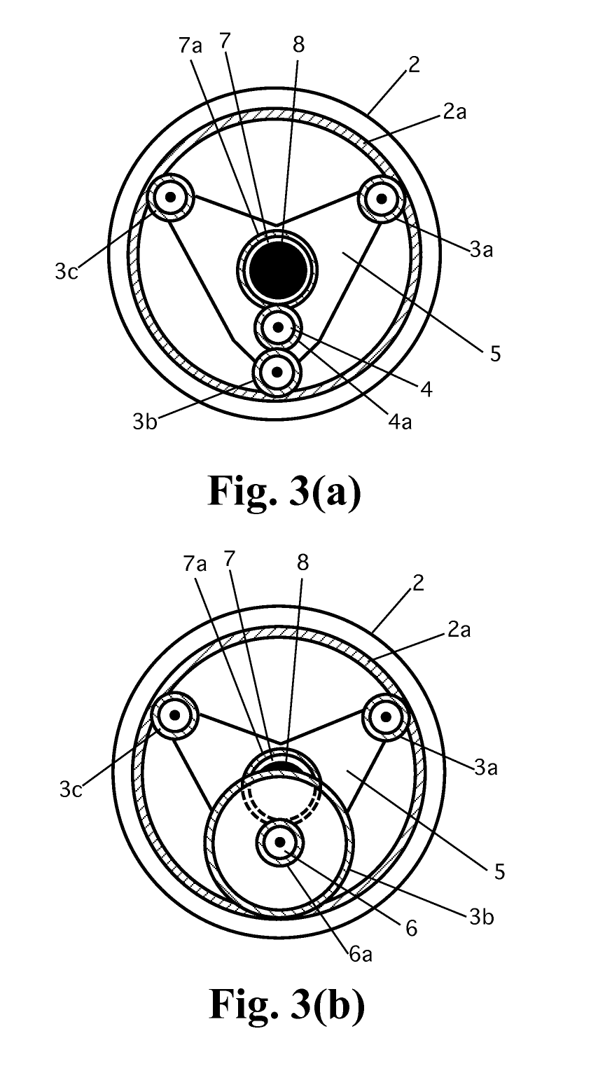

FIGS. 3(a) and 3(b) illustrate alternative gear arrangements. In FIG. 3(a), the gear 3b has gear 4 positioned between the gears 3b and 7a. The outer teeth of gear 3b are in contact with the gear teeth 4a of the gear 4, and the teeth 4a are in contact with the teeth 7a of the gear 7 of the spindle shaft 8. In this way, the rotational direction of the steering shaft 8 can be maintained in the same direction as that of the steering wheel 2. In FIG. 3(b), the gear 3b has the second gear 6 co-axially mounted on the same center axis. The outer teeth of gear 3b are in contact with the gear 2a of the outer ring 2, and the teeth 6a of the second gear 6 are in contact with the teeth 7a of the gear 7 of the spindle shaft 8. This configuration may be used to alter the mechanical advantage of the gear system in order to optimize the rotation angle and torque.

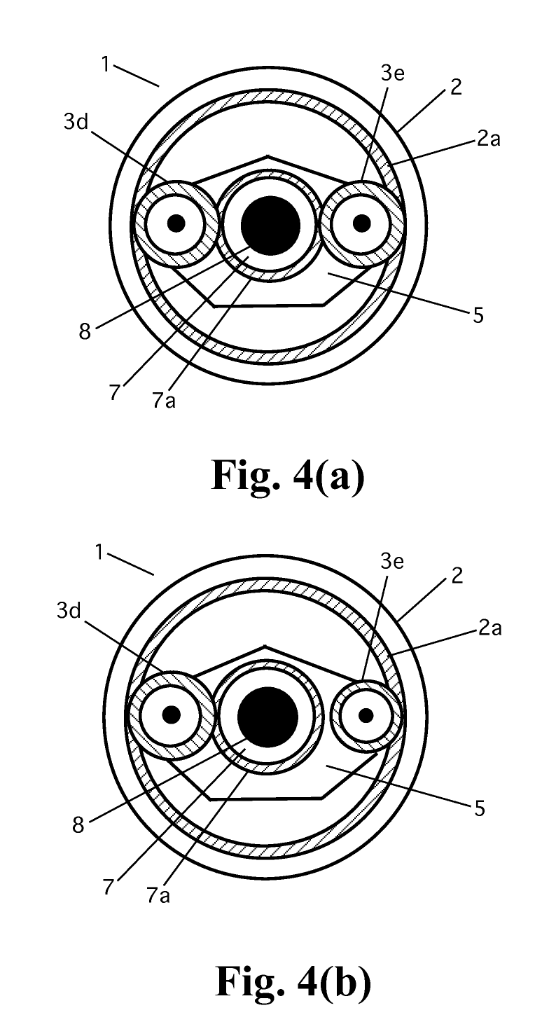

FIGS. 4(a) and 4(b) illustrate gear systems having two supporting gears 3d, 3e, instead of three supporting gears, as seen in FIG. 1(a). Both of the gears 3d, 3e, in FIG. 4(a), or one of the gears, for example, 3d in FIG. 4(b), may contact the teeth 7a of gear 7.

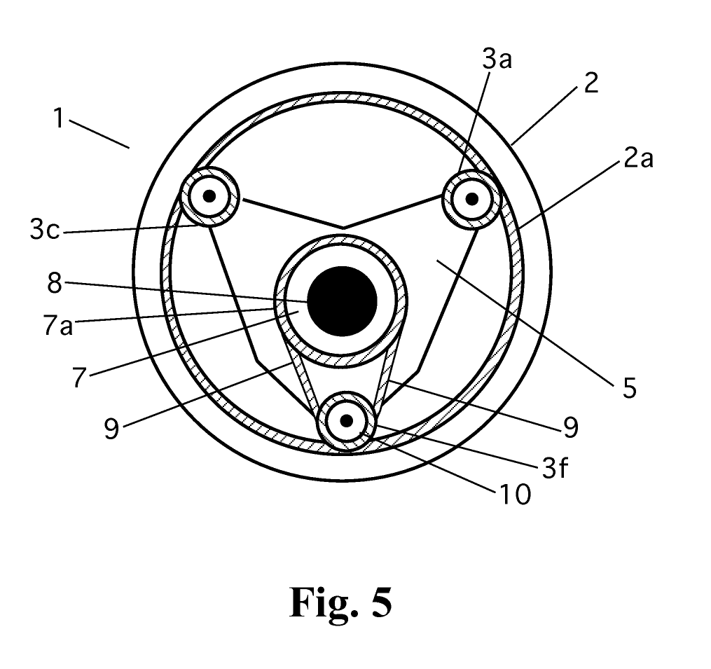

Instead of gears, other mechanical coupling devices, such as belt systems, can be used to transfer the driving torque force. In some embodiments, a toothed belt, such as a timing belt or a chain, may be used. FIG. 5 shows an embodiment where the mechanical coupling device is a belt 9. The gear 3f has the second gear 10 co-axially mounted on the same center axis. The belt 9 is used to transfer the driving force from the second gear 10 on the axis of the gear 3f to the gear 7 on the spindle shaft 8.

The previous embodiments showed a round steering wheel outer ring 2. However, the invention is not limited to this embodiment. In another embodiment, the present invention allows a non-circular steering wheel. This may be accomplished by using a belt type device instead of a circular gear for the steering wheel ring.

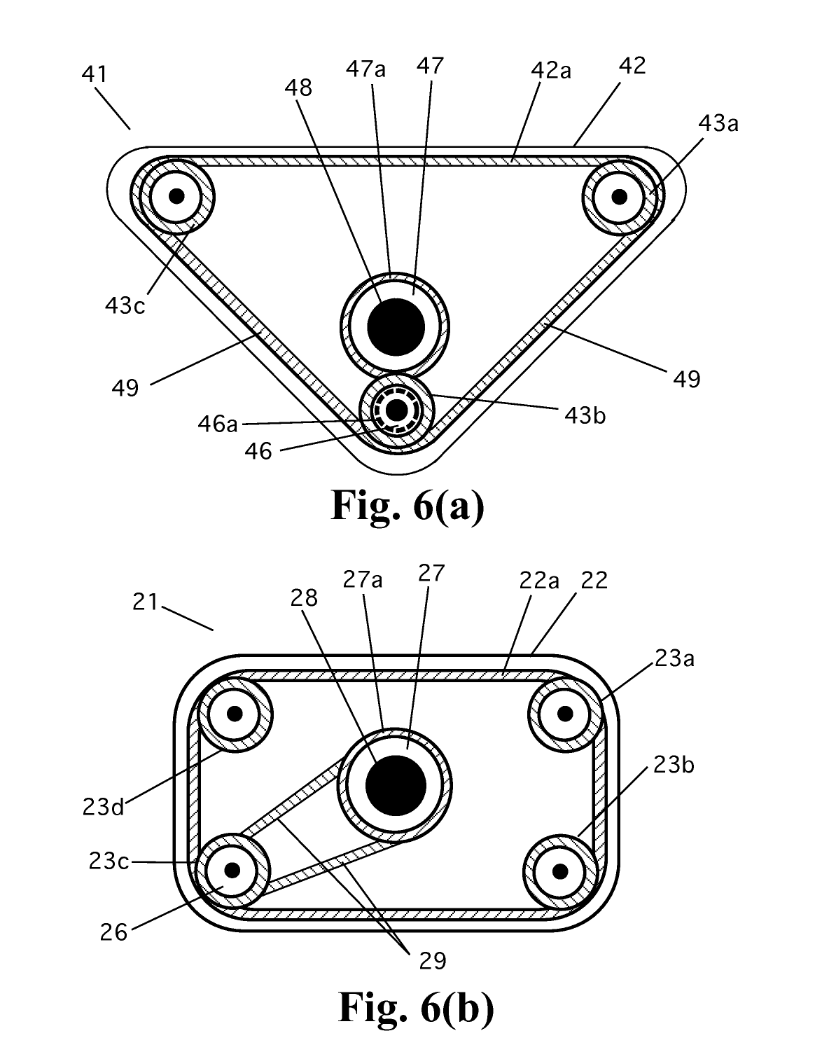

FIGS. 6(a) and (b) illustrate examples of triangular and rectangular shaped steering wheels, respectively. In FIG. 6(a), the outer ring 42 is formed as a triangular shape, and consists of a loop of flexible material having an inner surface 42a. The inner surface 42a may include teeth, which are used to grip and guide the flexible material around the gears 43a-43c. Each gear 43a-43c may have teeth which engage with the teeth on the inner surface 42a of the flexible material. In another embodiment, friction is relied upon to cause the gears 43a-43c to rotate when the outer ring 42 is rotated. One of the gears has the second gear 46 co-axially mounted on the central axis of the gear 43b. The gear teeth 46a of the second gear 46 is in contact with the gear teeth 47a of the gear of the spindle shaft 48. When the outer ring 42 is rotated, the rotational torque is transferred to the spindle shaft 48 through the gear 43b, the second gear 46, and the gear 47a. In another embodiment, a belt may be used instead of gear 46. FIG. 6(b) shows a rectangular steering wheel. The operation mechanism is very similar to the triangular one, but this figure shows an example using a belt for a mechanical coupling device. Of course, gears may be used as well. The outer ring 22 made of a loop of flexible material having an inner surface 22a. The inner surface 22a may include teeth, which are used to grip and guide the flexible material around the gears 23a-23d. One of the gears has the second gear 26 co-axially mounted on the central axis of the gear 23c. This second gear 26 is connected to the gear 27 of the spindle shaft with a loop belt 29. When the outer ring 22 is rotated, the rotational torque is transferred to the spindle shaft 28 through the gear 23c, the second gear 26, the belt 29 and the gear 27a.

In FIGS. 6(a) and 6(b), the placement of the gears 23a-d, 43a-c, defines the shape of the outer ring. In other words, the outer ring is flexible and may conform to an arbitrary shape. When fitted over a specific configuration of gears, it assumes that shape. This technique may be used to create a steering wheel in the shape of a polygon having three or more straight sides. Thus, in addition to triangles and rectangles, squares, pentagons and other shapes may also be created in this way.

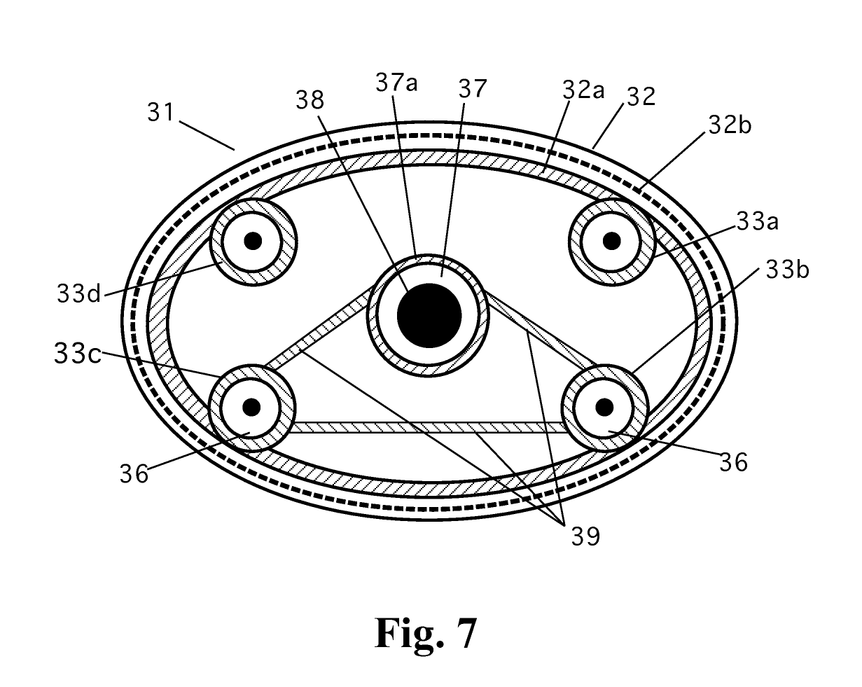

FIG. 7 illustrates an example of an elliptic shaped steering wheel 31. The outer ring 32 has a built-in stationary frame 32b which forces the flexible outer ring 32 to take on an elliptical shape. The stationary frame 32b may be held rigidly by attachment to the fixed frame structure (not shown) that supports gears 33a-33d. Friction of the contact surface between the flexible outer ring 32 and the stationary frame 32b may be reduced with friction-less materials and/or a bearing device. The operating mechanism is same as shown in FIG. 6(b), in that a chain or belt 39 is used to couple one or more of the gears 33a-33d to gear 37.

The embodiments show various numbers of gears that are used to support the outer ring. For example, FIG. 4(a) has two supporting gears 3d, 3e. FIG. 5 has three supporting gears 3a, 3c, 3f. FIG. 7 has four supporting gears 33a-d. However, the invention is not limited by these embodiments. Any number of supporting gears may be used to support the outer ring.

Another object of the invention is to provide a useful space in the central area of the steering wheel 1. The central area of the steering wheel is stationary and does not rotate when the steering wheel ring 2 is rotated. Therefore, the central area of the steering wheel 2 can be used for various purposes.

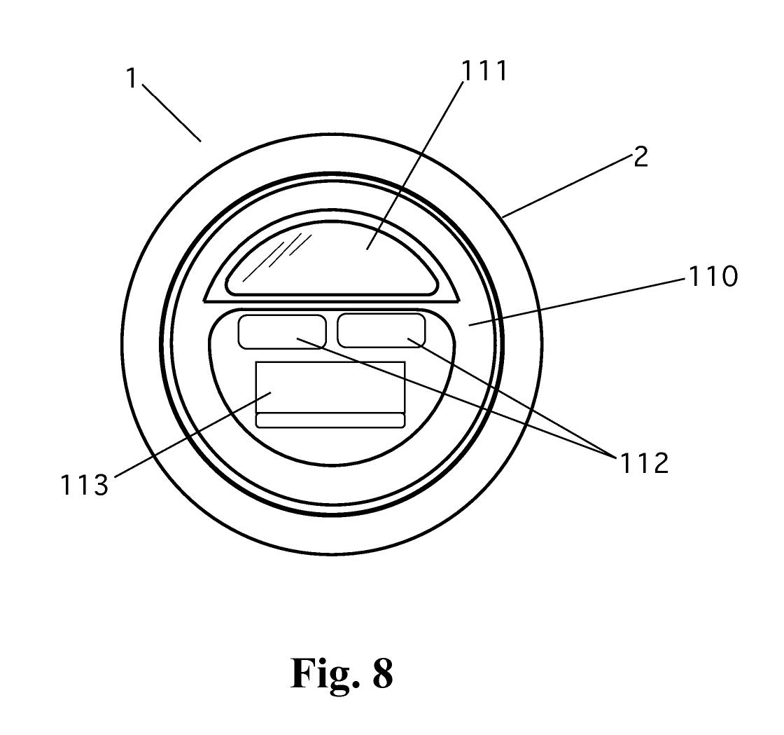

FIG. 8 illustrates an arrangement of the central area 110 of the steering wheel 1 having an open area 111 at the upper portion of the central area 110. The open area 111 allows the displays on the dashboard to be visible to the driver at all times, without blocking the view during driving. As described above, this open area 111 will not rotate when the steering wheel is turned, allowing visibility to the displays on the dashboard at all times. The lower portion of the steering wheel central area 110 may be used as a utility compartment of various purposes. For example, multi-information displays 112 including vehicle control system monitors of such parameters as temperature, time, radio, digital equipments, GPS receiver, and various control switches may be placed in the central area 110. In addition, accessory compartments 113, suitable to hold devices such as a cell phone and a portable GPS receiver, may be included in the central area 110.

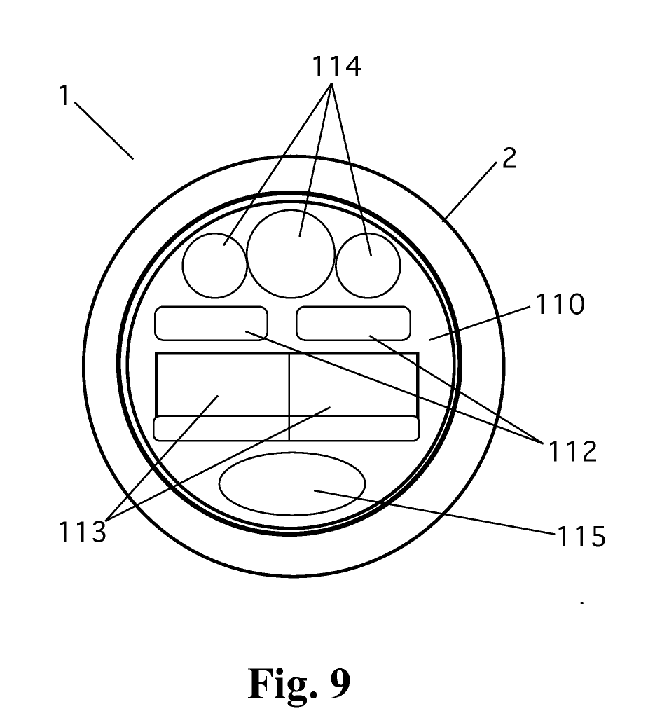

FIG. 9 illustrates another embodiment using the entire central area of the steering wheel 1 for utility and accessory compartments. For example, information typically displayed on the dashboard, such as speed, fuel, temperature and RPM, may be displayed on gauges 114 on the central area 110. In addition to digital information displays 112, and accessory compartments 113, a memo pad compartment 115 may be added. It should be noted that while digital information displays are recited, other displays, such as analog displays are also within the scope of the invention.

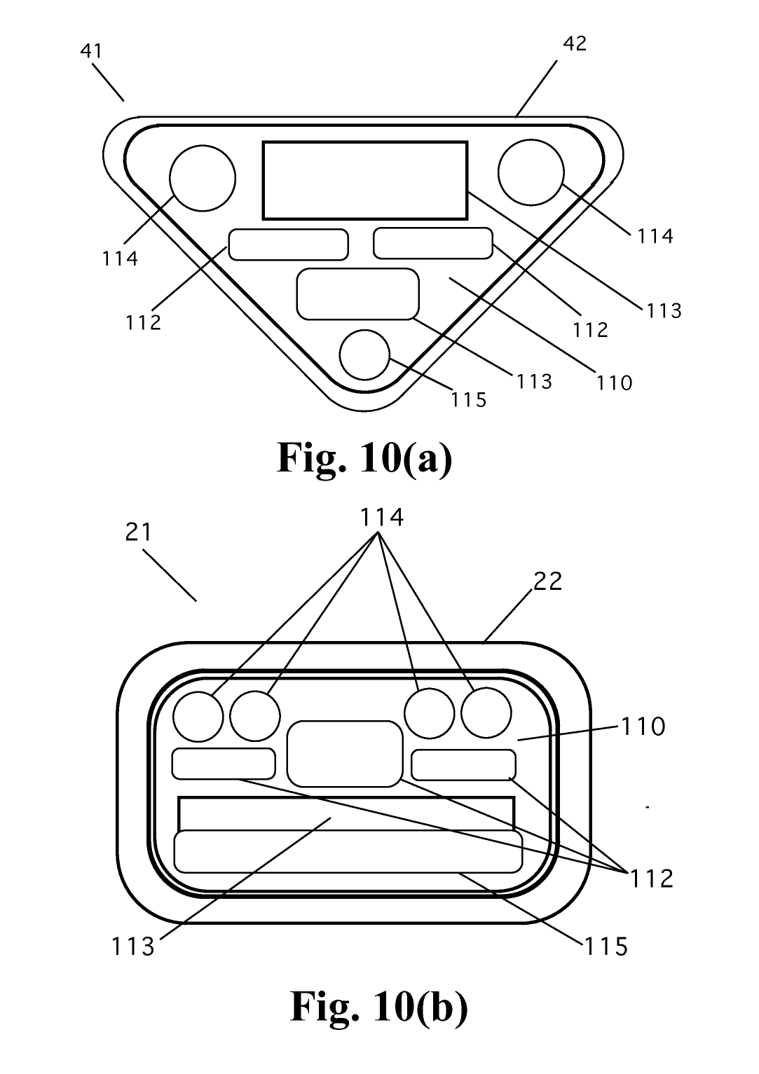

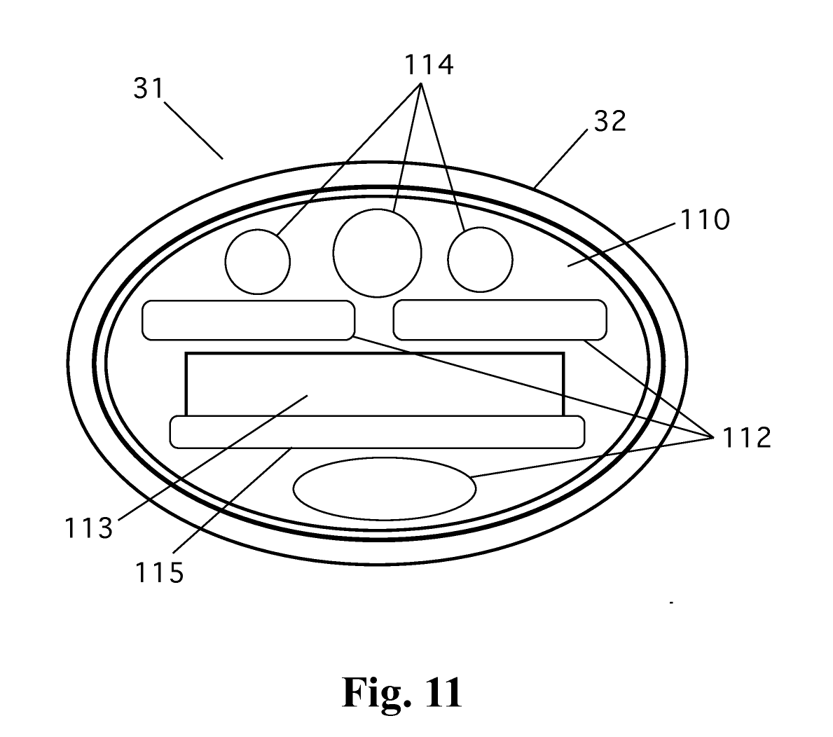

FIGS. 10(a), 10(b) and 11 illustrate usage examples of the triangular, rectangular and elliptic shaped steering wheels described in FIGS. 6(a), 6(b) and 7, respectively. Usages of the central area of the steering wheel are not limited to the above illustrations. Other usages are envisioned. In addition, different open regions may be included in the central area. For example, the open region does not need to be on the upper portion as shown in FIG. 8. Other and/or additional portions of the central area may be left open.

In addition, the use of a mechanical coupling device does not require the spindle shaft to be located at the center of the steering wheel, as is conventionally done. Rather, the spindle shaft may be offset from the center of the steering wheel and central area, if desired.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. A steering wheel comprising:
a rotatable outer ring;
a steering wheel spindle shaft;
a stationary central area covering said spindle shaft; and
a mechanical coupling device to couple said rotatable outer ring to said spindle shaft, such that rotation of said rotatable outer ring causes rotation of said spindle shaft.

2. The steering wheel of claim 1 further comprising a cavity housing for an air bag and a horn activation device in said central area.

3. The steering wheel of claim 1 wherein said outer ring comprises gear teeth on the surface of its inner perimeter.

4. The steering wheel of claim 1 wherein said spindle shaft comprises gear teeth on a surface.

5. The steering wheel of claim 1 wherein said mechanical coupling device comprises one or more gears.

6. The steering wheel of claim 1 wherein said mechanical coupling device comprises a belt.

7. The steering wheel of claim 5 wherein said one or more gears are supported on a structure frame.

8. The steering wheel of claim 1 wherein said outer ring is a substantially circular shape.

9. The steering wheel of claim 1 wherein said outer ring is a non-circular shape.

10. The steering wheel of claim 1 wherein the central area comprises a utility console.

11. The steering wheel of claim 1 wherein said central area has at least one open region, such that an operator can see displays located on a dashboard.

12. The steering wheel of claim 1 wherein said central area comprises one or more displays.

13. The steering wheel of claim 12 wherein said displays are selected from the group consisting of speedometer, tachometer, fuel gauge and thermometer.

14. The steering wheel of claim 1 wherein said outer ring comprises a flexible material covering a rigid frame, wherein said frame defines the shape of said outer ring, and said mechanical coupling device is coupled to said flexible material.

15. The steering wheel of claim 1 wherein said spindle shaft is not at the center of said steering wheel.

16. The steering wheel of claim 1 wherein said central area comprises one or more compartments.
